(19) United States
(12) Patent Application Publication
(10) Pub. No.: US 2015/0364919 A1
(43) Pub. Date: Dec. 17, 2015

(54) Method and System for Interfacing Inverter-Based Power Generator to Electric Power Grid

(71) Applicant: CUPERTINO ELECTRIC INC., San Jose, CA (US)

(72) Inventors: Steven Edward Schumer, San Jose, CA (US); Saurabh A. Samdani, San Jose, CA (US); James W. Waters, III, San Jose, CA (US)

(21) Appl. No.: 14/303,560

(22) Filed: Jun. 12, 2014

(51) Int. Cl. H02J 3/00; G05B 15/02

(52) U.S. Cl. CPC H02J 3/00; G05B 15/02

(57) ABSTRACT

Electrical power load data is obtained for a power consumption facility for a period of time of at least one year. A load duration curve is created for the power consumption facility for the period of time based on the electrical power load data. Anticipated electrical power production data is obtained for an inverter-based power generator for the period of time. A power generation curve is created for the inverter-based power generator for the period of time. The power generation curve is evaluated against the load duration curve to determine a required electrical power supply capacity and duration for an electrical storage system to cover peak power demand of the power consumption facility. An energy storage technology and configuration of the electrical storage system is determined for satisfying required electrical power supply capacity and duration for the electrical storage system to cover peak power demand of the power consumption facility.

### BACKGROUND

Solar photovoltaic (PV) electric power plants convert some of the energy in sunlight to direct current (DC) electricity. To make this energy usable to consumers, a power conversion system (PCS) changes the DC electricity to alternating current (AC) electricity through a process referred to as inversion. Inverter devices perform the inversion process by using solid-state switches to turn the DC electricity received as an input on and off at high frequency to create the AC electricity as an alternating positive to negative voltage. Following the inversion process, the AC electricity is further conditioned and injected into an electrical transmission system for distribution to and use by an electricity consumer.

At large scales, where the solar PV electric power plant is connected directly to the electric utility transmission/distribution system, the energy conversion and inversion processes fall considerably short of technical requirements which must be met in order for the energy from the PV electric power plant to be of sufficient quality and quantity to allow competition with non-inverter-based electricity generation, i.e., with synchronous rotating generator electricity generation, in the bulk (wholesale) power delivery marketplace. Also, it is a challenge to reliably connect static, inverter-based electric generators and their associated intermittent, renewable prime resources (such as solar and wind) to the electric power grid because the intermittent nature of their prime resources often cause the magnitude of their electricity output to be significantly less than what is required to satisfy contractual requirements associated with electrical load-following operation of the electric power grid. It is within this context that the present invention arises.

### SUMMARY OF THE INVENTION

In one embodiment, a method is disclosed for configuring an electrical storage system. The method includes obtaining historical electrical power load data for a given power consumption facility for a period of time, where the period of time is at least one year. The historical electrical power load data is represented in Watts of electrical power load as a function of time of day. The method also includes executing program instructions on a computer to create a load duration curve for the given power consumption facility for the period of time based on the obtained historical electrical power load data. The load duration curve correlates a percentage of peak power consumption by the given power consumption facility to a percentage of the period of time at which the given power consumption facility consumes the percentage of peak power consumption. The method also includes obtaining anticipated electrical power production data for a given inverter-based power generation facility for the period of time. The anticipated electrical power production data is represented in Watts of electrical power produced as a function of time of day. The method also includes executing program instructions on the computer to create a power generation curve for the given inverter-based power generation facility for the period of time based on the obtained anticipated electrical power production data. The power generation curve correlates a percentage of peak power production by the given inverter-based power generation facility to a percentage of the period of time at which the given inverter-based power generation facility produces the percentage of peak power production. The method also includes executing program instructions on the computer to evaluate the power generation curve against the load duration curve to determine a required electrical power supply capacity and duration for the electrical storage system to cover peak power demand of the given power consumption facility. The method includes determining an energy storage technology and configuration of the electrical storage system sufficient to satisfy the required electrical power supply capacity and duration for the electrical storage system to cover peak power demand of the given power consumption facility.

In one embodiment, a non-transitory computer readable storage medium having program instructions stored thereon for generating a configuration of an electrical storage system is disclosed. The computer readable storage medium includes program instructions for creating a load duration curve for a given power consumption facility for a period of time based on historical electrical power load data for the given power consumption facility for the period of time, where the period of time is at least one year. The historical electrical power load data is represented in Watts of electrical power load as a function of time of day. The load duration curve correlates a percentage of peak power consumption by the given power consumption facility to a percentage of the period of time at which the given power consumption facility consumes the percentage of peak power consumption. The computer readable storage medium includes program instructions for creating a power generation curve for a given inverter-based power generation facility for the period of time based on anticipated electrical power production data for the given inverter-based power generation facility for the period of time. The anticipated electrical power production data is represented in Watts of electrical power produced as a function of time of day. The power generation curve correlates a percentage of peak power production by the given inverter-based power generation facility to a percentage of the period of time at which the given inverter-based power generation facility produces the percentage of peak power production. The computer readable storage medium includes program instructions for evaluating the power generation curve against the load duration curve to determine a required electrical power supply capacity and duration for the electrical storage system to cover peak power demand of the given power consumption facility. The computer readable storage medium includes program instructions for determining an energy storage technology and configuration of the electrical storage system sufficient to satisfy the required electrical power supply capacity and duration for the electrical storage system to cover peak power demand of the given power consumption facility.

Other aspects and advantages of the invention will become more apparent from the following detailed description, taken in conjunction with the accompanying drawings, illustrating by way of example the present invention.

### BRIEF DESCRIPTION OF THE DRAWINGS

FIG. 1 shows a virtual power plant (VPP), in accordance with various embodiments of the present invention.

FIG. 2A shows a flowchart of a method for configuring an electrical storage system (ESS), in accordance with an embodiment of the present invention.

FIG. 2B shows a flowchart continuing from the method of FIG. 2A, in accordance with an embodiment of the present invention.

FIG. 2C shows a flowchart continuing from the method of FIG. 2A-2B, in accordance with an embodiment of the present invention.

FIG. 2D shows a flowchart continuing from the method of FIG. 2A-2C, in accordance with an embodiment of the present invention.

FIG. 2E shows a flowchart continuing from the method of FIG. 2A, in accordance with an embodiment of the present invention.

FIG. 2F shows a flowchart continuing from the method of FIG. 2E, in accordance with an embodiment of the present invention.

FIG. 3 shows an ESS capacity and duration determination chart, in accordance with an embodiment of the present invention.

FIG. 4 shows a chart that summarizes some of the technical requirements that may be applicable for connecting the VPP to the electric power grid, in accordance with an embodiment of the present invention.

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

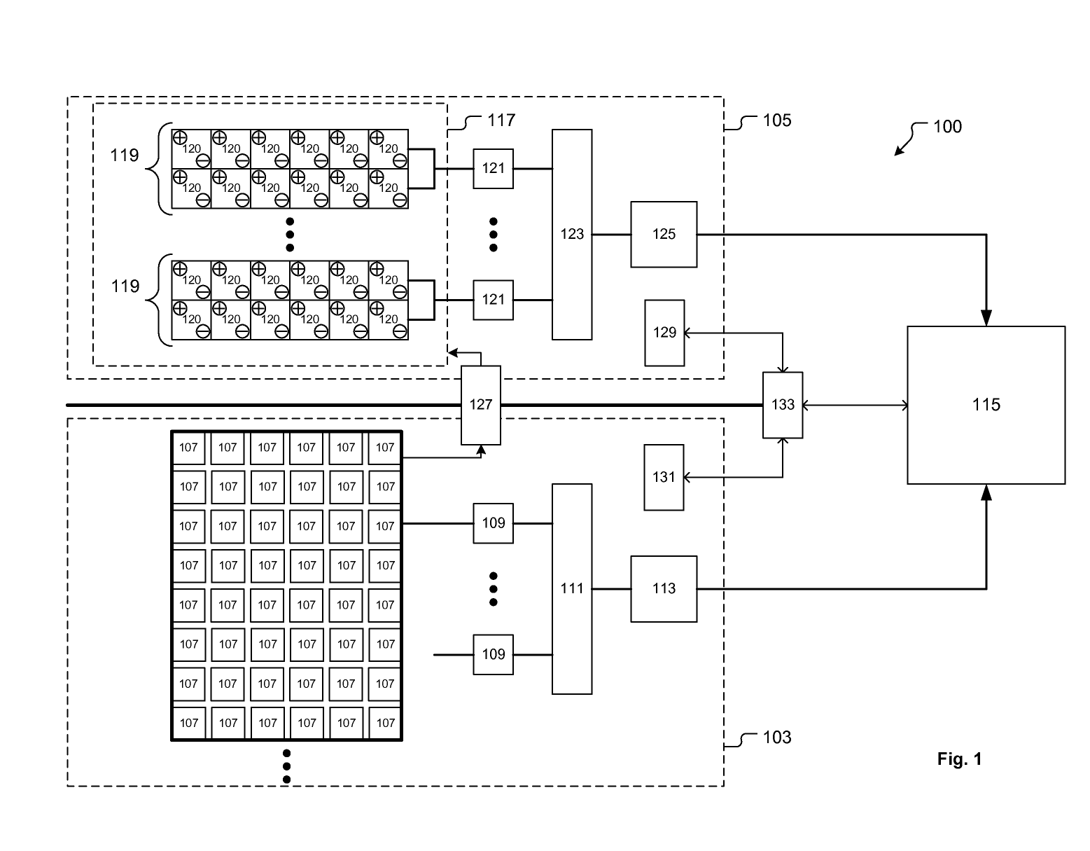

FIG. 1 shows a virtual power plant (VPP) 100, in accordance with various embodiments of the present invention. The VPP 100 includes a solar PV electric power plant (PVPP) 103, and an electrical storage system (ESS) 105. The PVPP 103 includes an array of solar PV cells 107. Each of the solar PV cells 107 is defined to convert solar energy into DC electricity. The PVPP 103 includes a number of inverters 109. Each inverter 109 is connected to receive as input DC electricity generated by a number of the solar PV cells 107. Each inverter 109 is defined to perform an inversion process on the DC electricity to output high frequency AC electricity. The outputs of the inverters 109 are connected to AC collection and utility interconnection switchgear 111, which is in turn connected to a step-up transformer 113, which is in turn connected to an electrical load 115. The electrical load 115 can be an electric power grid, or an end-use customer, or a combination thereof.

It should be understood that in another embodiment, the PVPP 103 can be replaced with one or more wind turbines, where each wind turbine is defined to rotate an electrical generator in response to wind force applied to blades of the wind turbine. In this embodiment, the DC electricity generated by the wind turbines is transmitted to the inverters 109 and is subsequently processed through the switchgear 111 and the transformer 113. Also, some embodiments may implement a combination of solar PV cells 107 and wind turbines, or other devices defined to convert a renewable prime resource into electricity. For ease of description, the VPP 100 will be described hereafter as including the PVPP 103.

In one embodiment, the ESS 105 includes a battery bank 117, including a number of battery strings 119. Each battery string 119 includes a number of batteries 120 connected in a serial manner. In the example of FIG. 1, each battery string 119 includes 12 serially connected batteries 120, with each battery delivering 50 Volts (V) at up to 50 Amps. Therefore, in the example of FIG. 1, each battery string 119 has a voltage of 600 V-DC, and produces a power output of 3 kilowatts (kW). It should be understood that in various embodiments the voltage and amperage of the batteries within the battery strings 119 within the battery bank 117 can be different from the example provided in FIG. 1. In various embodiments, the batteries 120 within the battery strings 119 can be defined to have essentially any combination of voltage and amperage necessary to provide a desired electrical power storage capacity and output performance from the battery bank 117.

The battery strings 119 within the battery bank 117 are connected to a number of inverters 121. Each inverter 121 is connected to receive as input DC electricity output from one or more of the battery strings 119. Each inverter 121 is defined to perform an inversion process on the DC electricity to output high frequency AC electricity. The outputs of the inverters 121 are connected to AC collection and utility interconnection switchgear 123, which is in turn connected to a step-up transformer 125, which is in turn connected to the electrical load 115.

In another embodiment, the ESS 105 can include energy storage devices other than batteries. For example, in some embodiments, the ESS 105 can include flywheels defined to store energy as angular momentum in a mechanical form for subsequent conversion to electricity. Also, in some embodiments, the ESS 105 can include a combination of energy storage devices, such as a combination of batteries and flywheels. For ease of description, the ESS 105 will be described hereafter as including the battery bank 117. However, it should be understood that in other embodiments the battery bank 117 in the ESS 105 can be defined as essentially any type of energy storage technology and configuration capable of storing energy and delivering energy on demand, such as flywheels and/or flow batteries, or combinations thereof, among others.

The VPP 100 includes an ESS controller and data acquisition system 129 defined and connected to control and monitor operation of the ESS 105. The VPP 100 also includes a PVPP controller and data acquisition system 131 defined and connected to control and monitor operation of the PVPP 103. The VPP 100 also includes a VPP master controller, data acquisition system, and communications hub 133 defined and connected to transfer/receive commands and data to/from both the ESS controller and data acquisition system 129 and the PVPP controller and data acquisition system 131. Also, the VPP master controller, data acquisition system, and communications hub 133 is connected to transfer/receive commands and data to/from an independent system operator of the electric power grid associated with the electrical load 115, or the end-use customer associated with the electrical load 115, or a combination thereof.

The VPP 100 also includes an interconnection controller 127 defined to control electrical connection of the DC electrical output from the solar PV cells 107 to the battery bank 117 to charge the battery strings 119 with DC electricity generated by the solar PV cells 107. Also, it should be understood that the ESS 105 is defined to connect to the electric power grid to receive AC electricity, convert the received AC electricity to DC electricity, and use this DC electricity to charge the battery strings 119 within the battery bank 117. It should be understood that charging of the battery strings 119 within the battery bank 117 can be done using electricity generated by the solar PV cells 107, or using electricity sourced from the electric power grid, or a combination thereof, on a charging schedule that is suitable for operation of the ESS 105 and VPP 100, under the control of the VPP master controller, data acquisition system, and communications hub 133.

While the VPP 100 of FIG. 1 provides an example VPP through which the methods and systems of the present invention can be implemented, it should be appreciated that the methods and systems described herein are not limited to implementation only with the VPP 100 configuration shown in FIG. 1. For example, the methods and systems disclosed herein can be implemented in an equally effective manner in other VPP configurations that have different battery bank configurations, and/or different solar PV cell configurations, and/or different inverter configurations in either or both of the ESS 105 and PVPP 103, and/or use renewable power sources other than solar PV cells, and/or use energy storage devices other than batteries.

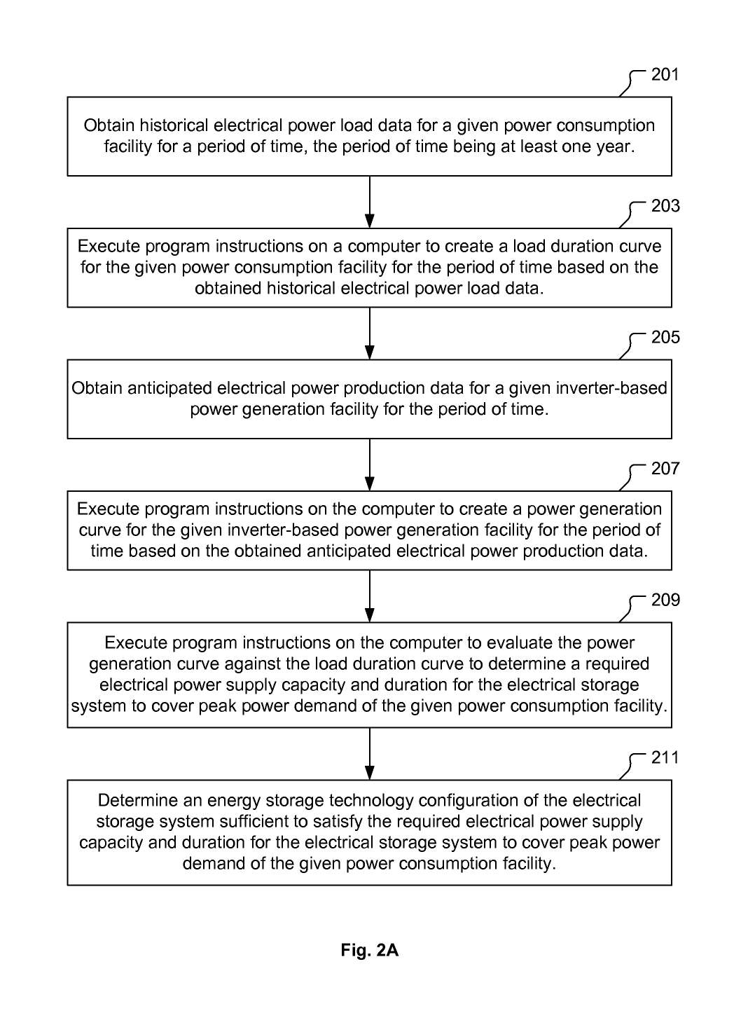

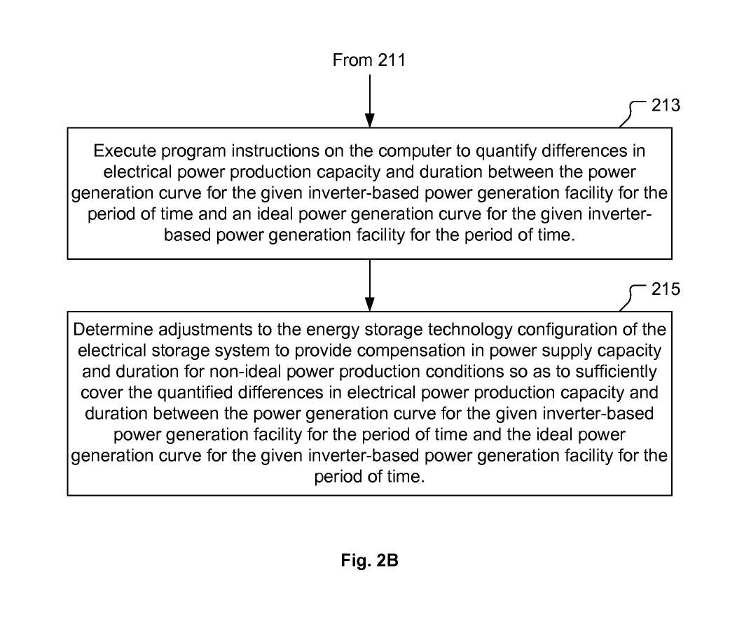

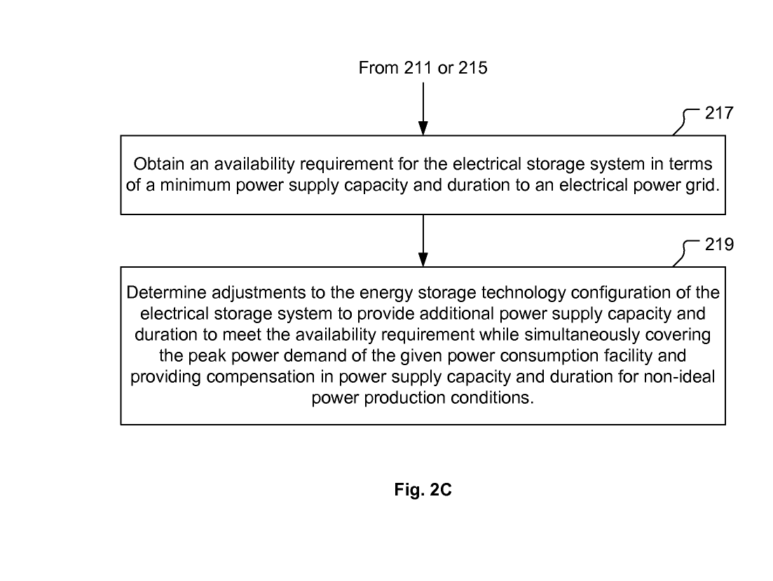

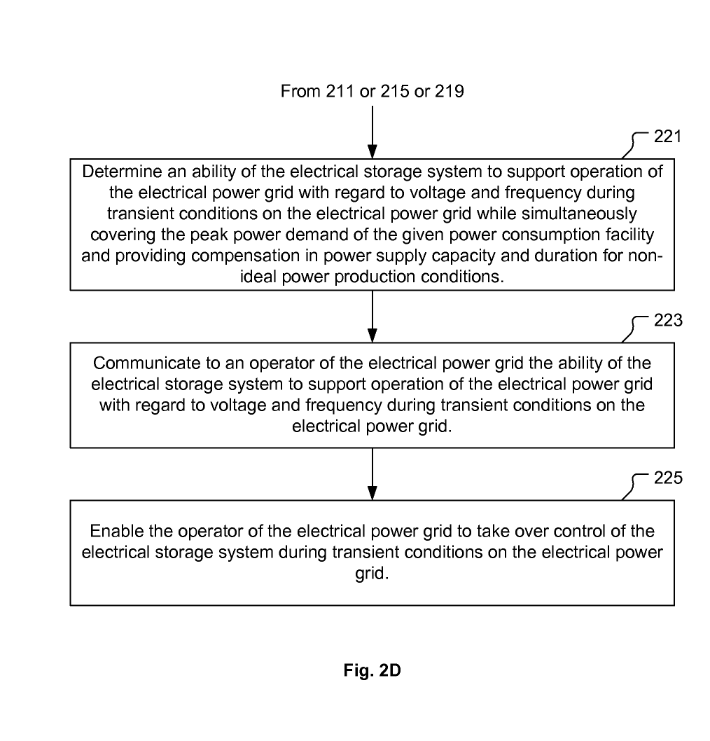

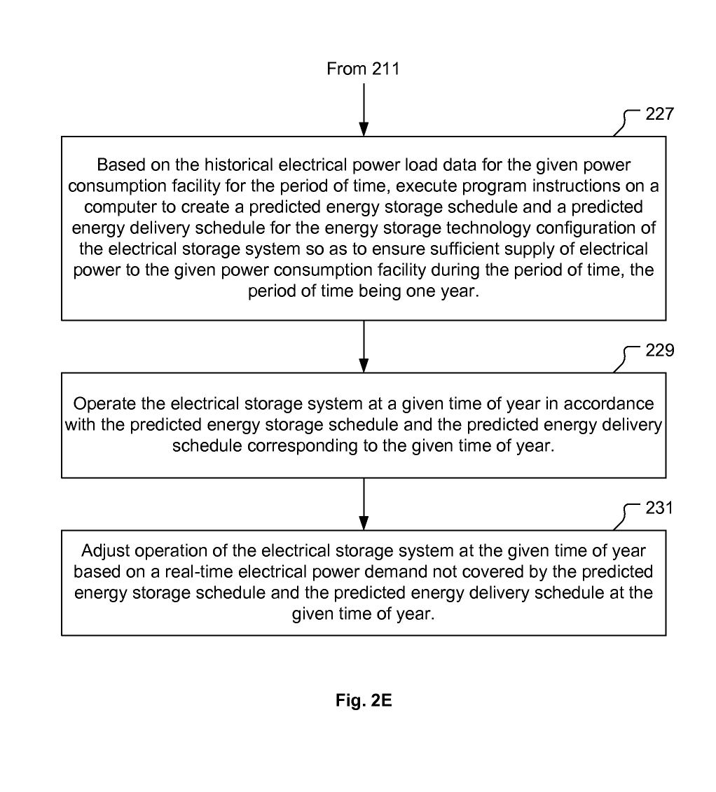

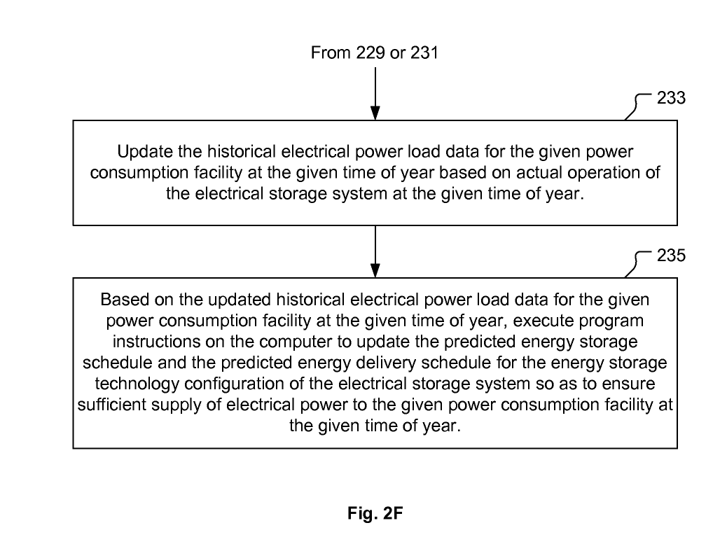

FIG. 2A shows a flowchart of a method for configuring an electrical storage system (such as the ESS 105 of FIG. 1), in accordance with an embodiment of the present invention. The method includes an operation 201 for obtaining historical electrical power load data for a given power consumption facility for a period of time. Within the context of FIG. 1, the given power consumption facility is the entity responsible for the electrical load 115. In one embodiment, the period of time is at least one year. In other embodiments, the period for time is less than one year, but includes a sufficient amount of data to estimate a yearly electrical power load schedule. The given power consumption facility is essentially any entity that consumes electrical power. For example, in one embodiment, the given power consumption facility is a manufacturing plant. In another example embodiment, the given power consumption facility is a group of power consumers that can be collectively viewed as a single end-user of electrical power, such as an industrial park, or a residential community, or essentially any other entity that can be managed behind a common power meter. Also, in one embodiment, the historical electrical power load data is represented in Watts of electrical power load as a function of time of day. In some embodiments, operation 201 can include performing a computer-based simulation to estimate the annual power consumption schedule of the given power consumption facility.

As mentioned, in one embodiment, the electrical power load data for the given power consumption facility is obtained for a minimum period of one year. However, this electrical power load data can also be updated as additional electrical power load data becomes available through operation of the given power consumption facility. In some embodiments, the electrical power load data is defined such that at least one electrical power load data value exists for each 15-minute interval within the minimum period of one year, thereby resulting in at least 35,000 electrical power load data values for the one-year period. In some embodiments, the electrical power load data is defined such that at least one electrical power load data value exists for each 1-minute interval within the minimum period of one year, thereby resulting in at least 500,000 electrical power load data values for the one year period. When the electrical power load data is based on actual electrical power used by the given power consumption facility, it is possible for there to be large fluctuations and even periods of zero electrical power load, such as when the given power consumption facility is off-line or down for maintenance in whole or in part. For this reason, the historical electrical power load data obtained in operation 201 can be processed through an algorithm to remove intervals of zero electrical power load or other clearly corrupt data points. This algorithmic processing can be performed by program instructions operating on a computer processor. It should be understood, however, that this algorithmic processing of the historical electrical power load data is done in a manner to preserve the historical integrity of the data, and so as not to introduce artificial bias.

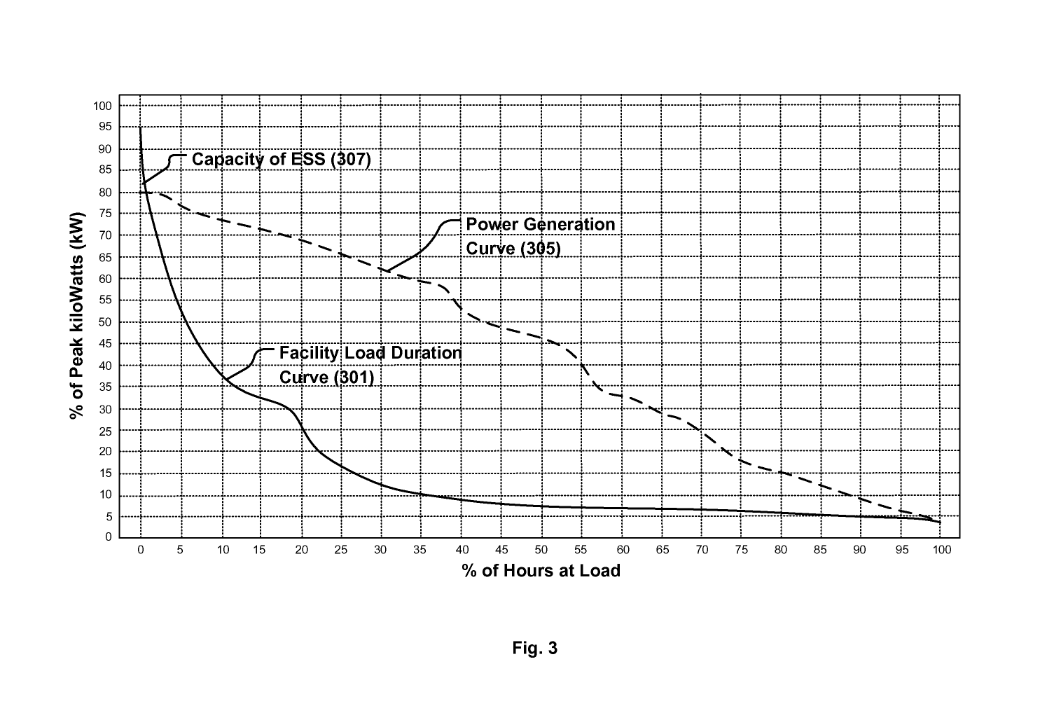

With reference back to FIG. 2A, the method continues with an operation 203 for executing program instructions on a computer to create a load duration curve for the given power consumption facility for the period of time based on the historical electrical power load data obtained in operation 201. The load duration curve correlates a percentage of peak power consumption by the given power consumption facility to a percentage of the period of time at which the given power consumption facility consumes the percentage of peak power consumption. An example of the load duration curve created in operation 203 is shown in the chart of FIG. 3 as a facility load duration curve 301. FIG. 3 shows an ESS capacity and duration determination chart, in accordance with one embodiment of the present invention. It should be understood that the facility load duration curve 301 is an example provided for descriptive purposes. In practice, different facility load duration curves can vary in shape from the facility load duration curve 301, depending on the historical electrical power load data for the given power consumption facility. Also, in one embodiment, the facility load duration curve 301 represents power consumed through a power meter of the given power consumption facility. In another embodiment, the facility load duration curve 301 represents firm electrical power delivered to the given power consumption facility from an electrical power generator.

In some embodiments, prior to executing program instructions on the computer to create the load duration curve in operation 203, the method includes executing program instructions on the computer to perform a smoothing operation on the obtained historical electrical power load data so as to ensure existence of either an actual electrical power load data point or an interpolated electrical power load data point at a minimum interval over the period of time, and so as to remove any corrupt electrical power load data point(s) over the period of time. In one embodiment, the minimum interval over the period of time is a 15-minute interval. However, in other embodiments, the minimum interval over the period of time can be different than fifteen minutes, so long as any significant variation in the time-dependent behavior of the electrical power load is represented in the obtained historical electrical power load data.

Depending on the precision of the historical electrical power load data, identification of corrupt data points can include performing a high-resolution analysis of the statistical distribution of the historical electrical power load data on annual, seasonal, monthly, or even daily bases. For example, the historical electrical power load data can be statistically analyzed to determine its mean, standard deviation, and quartiles, among other statistical parameters. To facilitate elimination of corrupt data points, the statistical analysis of the historical electrical power load data can include selection of a valid data range that encompasses at least 95% of the data points. For example, if the historical electrical power load data is determined to follow a normal statistical distribution, the valid data range may be defined to encompass data points that falls within two standard deviations about the mean.

Following removal of any corrupt data points and filling of any zero intervals by interpolation, the statistical analysis of the historical electrical power load data can include calculation of a confidence interval and reliability of data to evaluate a goodness of fit of the facility load duration curve 301 to the historical electrical power load data. In this manner, the facility load duration curve 301 that is based on the historical electrical power load data represents a true electrical power load for the given power consumption facility at all times during the period of time within a selected confidence interval. In one embodiment, the selected confidence interval is set at 95%. However, in other embodiments, the selected confidence interval may be more or less than 95%. If necessary, the historical electrical power load data can be supplemented as needed in an iterative manner until the facility load duration curve 301 is capable of satisfying the selected confidence interval, or a more relaxed confidence interval may be accepted.

With reference back to FIG. 2A, the method continues with an operation 205 for obtaining anticipated electrical power production data for a given inverter-based power generation facility for the period of time. Within the context of FIG. 1, the given inverter-based power generation facility is represented by the PVPP 103. In one embodiment, the anticipated electrical power production data is represented in Watts of electrical power produced as a function of time of day. It should be understood that the given inverter-based power generation facility is connected to supply electrical power to the given power consumption facility. In one embodiment, the given inverter-based power generation facility is controlled by the given power consumption facility. However, in other embodiments, the given inverter-based power generation facility is controlled by an entity that is not the given power consumption facility.

Again, within the context of the example VPP 100 of FIG. 1, the given inverter-based power generation facility is represented as the PVPP 103. However, in various embodiments, the given inverter-based power generation facility generates electrical power through one or both of solar PV cells and wind turbines. Additionally, the methods and systems described herein can be equally applied to other types of inverter-based power generation facilities in which renewable, intermittent power sources are harnessed to produce electricity, such as geothermal-based electrical power plants, ocean wave-based electrical power plants, and tidal-based electrical power plants, among others.

The method proceeds with an operation 207 for executing program instructions on the computer to create a power generation curve for the given inverter-based power generation facility for the period of time based on the obtained anticipated electrical power production data. The power generation curve correlates a percentage of peak power production by the given inverter-based power generation facility to a percentage of the period of time at which the given inverter-based power generation facility produces the percentage of peak power production. An example of the power generation curve created in operation 207 is shown in the chart of FIG. 3 as a power generation curve 305. It should be understood that the power generation curve 305 is an example provided for descriptive purposes. In practice, different power generation curves can vary in shape from the power generation curve 305, depending on the electrical power generating capability for the given inverter-based power generation facility.

In one embodiment, the anticipated electrical power production data used to create the power generation curve 305 is obtained from actual operation of an existing inverter-based power generation facility over the period of time of at least one year. However, in another embodiment, the method can include executing program instructions on a computer to simulate electrical power generation by the given inverter-based power generation facility during the period of time to produce the anticipated electrical power production data for the period of time, which is in turn used to create the power generation curve 305. Also, in other embodiments, some data from actual operation of an existing inverter-based power generation facility is combined with some data produced through computer simulation of the given inverter-based power generation facility to yield the anticipated electrical power production data used to create the power generation curve 305. It should be understood that the anticipated electrical power production data used to create the power generation curve 305 is representative of the electrical power production capability of the given inverter-based power generation facility that is installed within the VPP 100.

The method proceeds with an operation 209 for executing program instructions on the computer to evaluate the power generation curve 305 against the load duration curve 301, to determine a required electrical power supply capacity and duration in order for the ESS 105 to cover peak power demand of the given power consumption facility. With reference to FIG. 3, the required capacity and duration of the ESS 105 is represented by the area 307 that is below the load duration curve 301 and above the power generation curve 305. More specifically, the required electrical power supply capacity for the ESS 105 to cover peak power demand of the given power consumption facility is determined by calculating an amount of electrical power corresponding to a maximum extent by which the load duration curve 301 exceeds the power generation curve 305 at any given time within the period of time, as measured along the vertical axis. In the example of FIG. 3, the load duration curve 301 exceeds the power generation curve 305 by a maximum extent of 15% of the peak kilowatts. Therefore, in this example the ESS 105 needs to have an electrical power supply capacity capable of covering 15% of the peak kilowatt production of the inverter-based power generation facility, i.e., of the PVPP 103.

Also, with reference to FIG. 3, the required electrical power supply duration for the ESS 105 to cover peak power demand of the given power consumption facility is determined by calculating a total amount of time at which the load duration curve 301 exceeds the power generation curve 305 during the period of time, as measured along the horizontal axis. In the example of FIG. 3, the load duration curve 301 exceeds the power generation curve 305 by a total amount of time of 1% of the hours at load. Therefore, in this example the ESS 105 needs to have an electrical power supply duration capable of covering 15% of the peak kilowatt production of the inverter-based power generation facility, i.e., of the PVPP 103, for a period of time of at least 1% of the hours at load, or for about 88 hours given a one year time period at load. In this manner, when the PVPP 103 is not able to satisfy the peak electrical demand of the given power consumption facility, the ESS 105 is brought online to supplement the power supplied by the PVPP 103 to cover the peak power demand of the given power consumption facility. Therefore, if the PVPP 103 has a rated output of 200 kW, the ESS 105 should be capable of providing 30 kW for 88 hours, or an annual total of 264 kilowatt-hours.

The method continues with an operation 211 for determining an energy storage technology (e.g., a battery bank 117 or other type of energy storage technology) configuration of the ESS 105 sufficient to satisfy the required electrical power supply capacity and duration for the ESS 105 to cover peak power demand of the given power consumption facility. In one embodiment, such as shown in FIG. 1, the battery bank configuration 117 is specified by a number of batteries 120, respective voltages of the number of batteries 120, respective amperages of the number of batteries 120, and electrical connections between terminals of the number of batteries 120. It should be understood that the method for configuring the ESS 105 as disclosed herein represents a custom engineering solution based on a proprietary analysis of electrical power production data obtained from recording of historical electrical power generation performance of an existing electric power generator, e.g., of an existing electric power plant, and/or from a suitable modeling of the electrical power generation performance of an as yet un-built electric power plant, electrical substation, or end-use customer electrical service.

The method can also include use of iterative techniques to calculate a series of ESS 105 performance improvements assuming various, general, storage apparatus charge and discharge characteristics. Sufficient iterations will yield a set of possible energy storage technology capacity and energy supply characteristics that converge on an ESS 105 design solution that is technically optimal with respect to enhancing electrical power generation asset, i.e., PVPP 103, performance and with respect to contributing to the stability and resilience of the transmission or distribution system to which it is connected.

FIG. 2B shows a flowchart continuing from the method of FIG. 2A, in accordance with an embodiment of the present invention. From the operation 211, the method can proceed with an operation 213 for executing program instructions on the computer to quantify differences in electrical power production capacity and duration between the power generation curve 305 for the given inverter-based power generation facility for the period of time and an ideal power generation curve for the given inverter-based power generation facility for the period of time. The ideal power generation curve for the given inverter-based power generation facility is based on ideal power production conditions for the given inverter-based power generation facility. For example, if the given inverter-based power generation facility is the PVPP 103, then the ideal power generation curve will be based on maximum clear sky power production conditions throughout the year. Similar to the power generation curve 305, the ideal power generation curve correlates a percentage of peak power production by the given inverter-based power generation facility under ideal power production conditions to a percentage of the period of time at which the given inverter-based power generation facility produces the percentage of peak power production under ideal power production conditions.

From the operation 213, the method proceeds with an operation 215 for determining adjustments to the energy storage technology (e.g., the battery bank 117 or other type of energy storage technology) configuration of the ESS 105 to provide compensation in power supply capacity and duration for non-ideal power production conditions so as to sufficiently cover the quantified differences in electrical power production capacity and duration between the expected power generation curve 305 for the given inverter-based power generation facility for the period of time and the ideal power generation curve for the given inverter-based power generation facility for the period of time. In one embodiment, sufficient coverage of the quantified differences in electrical power production capacity and duration between the expected power generation curve 305 for the given inverter-based power generation facility for the period of time and the ideal power generation curve for the given inverter-based power generation facility for the period of time exists when a sum of the electrical power supply capacity for the ESS 105 and the electrical power production capacity of the given inverter-based power generation facility is at least 95% of the electrical power production capacity of the given inverter-based power generation facility under ideal power production conditions at all times during the period of time, i.e., under maximum clear sky power production conditions throughout the year in the case of the PVPP 103.

In other words, the ESS 105 is defined to provide for injection of power from the ESS 105 to compensate for differences between actual PVPP 103 power production and ideal PVPP 103 production, either by matching the expected maximum clear sky power production of the PVPP 103 for the current time of year, or by ensuring that the VPP 100 is capable of supplying electric power within a target percentage of the expected maximum clear sky power production of the PVPP 103 for the current time of year. In one embodiment, the target percentage is 95% of the expected maximum clear sky power production of the PVPP 103 for the current time of year. However, in other embodiments, the target percentage can be different than 95%. This process of injecting electrical power from the ESS 105 to supplement the power produced by the PVPP 103 to stay within a target percentage of the expected maximum clear sky power production of the PVPP 103 for the given time of year is referred to as “smoothing.” It should be understood that the smoothing process provides for continuous optimization of the power output by the VPP 100 to take maximum advantage of the available renewable resources, i.e., solar or wind resource. Also, it should be understood that the smoothing process may require adjustment of the ESS 105 energy storage technology and/or configuration and/or energy storage schedule to ensure that the ESS 105 has sufficient electrical power discharge capacity and duration to ensure that the electrical power output of the VPP 100 is maintained within the target percentage of the expected maximum clear sky power production of the PVPP 103 for the given time of year.

In one embodiment, the smoothing process is performed using a power injection rate from the ESS 105 based on 15-minute intervals. During the smoothing process, if the ESS 105 electrical charge storage capacity and/or electrical discharge duration is not sufficient to maintain the electrical power output of the VPP 100 within the target percentage of the expected maximum clear sky power production of the PVPP 103 for the given time of year, the ESS 105 energy storage technology and/or configuration can be adjusted as needed, and/or the target percentage can be reduced to a lower but still acceptable target percentage. The smoothing process also includes calculation of a schedule of incremental electrical power deliveries from the ESS 105 to the electrical load 115 to stay at or above the target percentage of the expected maximum clear sky power production of the PVPP 103 for the given time of year. Also, given the calculated schedule of incremental power deliveries from the ESS 105, an energy storage schedule for the ESS 105 can be calculated to optimize electrical power contributed from the PVPP 103 to the electrical load 115. In some embodiments, the ESS 105 may be charged from either the PVPP 103 or from the electric power grid. Therefore, in calculating the energy storage schedule for the ESS 105, it may be more cost effective to store energy in the ESS 105 (e.g., charge the batteries 120) through purchase of electricity from the electric power grid at night time, rather than store energy in the ESS 105 using power produced by the PVPP 103 during the daytime when the wholesale price of electricity is higher.

FIG. 2C shows a flowchart continuing from the method of FIG. 2A-2B, in accordance with an embodiment of the present invention. From either of operations 211 or 215, the method can proceed with an operation 217 for obtaining an availability requirement for the electrical storage system in terms of a minimum power supply capacity and duration to an electric power grid. Then, an operation 219 is performed to determine adjustments to the energy storage technology (e.g., the battery bank 117 or other type of energy storage technology) configuration of the ESS 105 to provide additional power supply capacity and duration to meet the availability requirement, while simultaneously covering the peak power demand of the given power consumption facility and providing compensation in power supply capacity and duration for non-ideal power production conditions of the PVPP 103. For example, operation 219 can include selection of an incremental increase in ESS 105 capacity to allow for guaranteed availability of a predetermined electrical power capacity, e.g., a predetermined megawatt (MW) capacity, over a predetermined time period, e.g., such as for example 90% of the days when electrical power production by the PVPP 103 is possible, resulting in a guaranteed VPP 100 availability in terms of power output, such as megawatt-hours (MWh). It should be understood that the predetermined electrical power capacity and predetermined time period associated with meeting the availability requirement can be set as needed based on the obtained availability requirement.

Also, in determining the incremental increase in ESS 105 capacity to allow for meeting the availability requirement, it should be understood that the minimum incremental increase in the ESS 105 capacity is in addition to the ESS 105 capacity established to meet existing committed, dispatchable electrical power demand. Also, in some embodiments, the ESS 105 capacity is increased in operation 219 to ensure that the ESS 105 can provide power to the electric power grid to satisfy the availability requirement even when the PVPP 103 is not available to produce electrical power. This will result in an increase in ESS 105 capacity to compensate for downtime of the PVPP 103 in order to satisfy the availability requirement to the electric power grid. As a result of operations 217 and 219, an hourly schedule of ESS 105 operation can be defined and guaranteed to an Independent System Operator (ISO) or to a Regional Transmission Operator (RTO) of the electric power grid, thereby allowing the naturally intermittent PVPP 103 electrical power generation resource to be dispatched, i.e., scheduled, in a similar manner to a traditional turbine-based electric power generator.

FIG. 2D shows a flowchart continuing from the method of FIG. 2A-2C, in accordance with one embodiment of the present invention. From either of operations 211, 215, or 219, the method can proceed with an operation 221 for determining an ability of the ESS 105 to support operation of the electric power grid with regard to voltage and frequency during transient conditions on the electric power grid, while simultaneously covering the peak power demand of the given power consumption facility and providing compensation in power supply capacity and duration for non-ideal power production conditions of the PVPP 103. The operation 221 can also be characterized as determining an ability of the ESS 105 to enable the VPP 100 to participate in an ancillary services market of the electric power grid. In order to participate in the ancillary service market, the ESS 105 through the VPP 100 is made available to respond to electrical power supply orders from an operator of the electric power grid, e.g., from an ISO or RTO, in real-time under the control of a computer control system, where the electrical power supply orders are based on real-time operating conditions and needs of the electric power grid. For example, the operation 221 can include use of electric power grid impedance and load flow data to calculate an ability of the ESS 105 by way of the VPP 100 to support and regulate interconnection bus voltage and frequency on the electric power grid during transient voltage conditions on the electric power grid.

From the operation 221, the method continues with an operation 223 to communicate to the operator of the electric power grid the ability of the ESS 105/VPP 100 to support operation of the electric power grid with regard to voltage and frequency during transient conditions on the electric power grid. Then, an operation 225 is performed to enable the operator of the electric power grid to take over control of the ESS 105 by way of the VPP 100 during transient conditions on the electric power grid. In one embodiment, the operator of the electric power grid can input a signal to the VPP 100 indicating that certain system operations are needed to provide support to the electric power grid. In another embodiment, a control system of the electric power grid can communicate instructions autonomously to the VPP master controller, data acquisition, and communications hub 133 to direct the ESS 105/VPP 100 to perform certain system operations as needed to provide support to the electric power grid. As a result of operation 225, the ESS 105/VPP 100 can be harnessed by the operator of the electric power grid to adjust a ratio of real-to-reactive power, to prohibit generation of reactive power in favor of injection of real power, e.g., in favor of immediate injection of 100% real power, or any combination thereof, among other tasks. Additionally, with the hourly schedule of ESS 105 operation published, the operator of the electric power grid can control the ESS 105/VPP 100 with consideration of the established electric power availability and capacity limits of the ESS 105.

FIG. 2E shows a flowchart continuing from the method of FIG. 2A, in accordance with one embodiment of the present invention. From the operations 211, the method can proceed with an operation 227 for executing program instructions on a computer to create a predicted energy storage schedule and a predicted energy delivery schedule for the energy storage technology and configuration of the ESS 105, based on the historical electrical power load data for the given power consumption facility for the period of time, so as to ensure sufficient supply of electrical power to the given power consumption facility during the period of time, where the period of time is one year. For example, in the embodiment where the energy storage technology and configuration of the ESS 105 is defined as the battery bank 117, operation 227 executes program instructions on the computer to create a predicted charge schedule and a predicted discharge schedule for the batteries 120 in the battery bank 117. Then, the method proceeds with an operation 229 in which the ESS 105 is operated at a given time of year in accordance with the predicted energy storage schedule and the predicted energy delivery schedule corresponding to the given time of year, as created in operation 227.

Therefore, in one example embodiment, in accordance with operation 229, the VPP master controller, data acquisition, and communications hub 133 communicates with the PVPP controller and data acquisition system 131 and with the ESS controller and data acquisition system 129 and with the interconnection controller 127 to direct operation of the VPP 100 in accordance with the predicted energy storage schedule (e.g., predicted charge schedule) and the predicted energy delivery schedule (e.g., predicted discharge schedule) for the battery bank 117 configuration of the ESS 105. In this manner, the ESS 105 and PVPP 103 are operated such that the VPP 100 functions as a single, autonomous electric generating system. Also, both the ESS 105 and PVPP 103 are controlled so as to meet the electric power delivery schedule. Because the conditions governing operation of the electric power grid vary constantly and may be abruptly changed to meet the needs of the moment, the VPP 100 may be made available to operate under conditions dictated by an outside agency, such as the operator of the electric power grid.

Therefore, the method can also include operating the ESS 105/VPP 100 in accordance with an order issued by the operator of an electric power grid to which the electrical storage system is connected, where the order causes a real-time electrical power demand not covered by the predicted energy storage schedule and the predicted energy delivery schedule at the given time of year as created in operation 227. In following, the method includes an operation 231 for adjusting operation of the ESS 105/VPP 100 at the given time of year based on the real-time electrical power demand not covered by the predicted energy storage schedule and the predicted energy delivery schedule at the given time of year. In this manner, as the ESS 105/VPP 100 operate in accordance with a directive to adjust from scheduled operations, the adjustments are fed back into the ESS 105/VPP 100 scheduling algorithm to provide for real-time revision of the predicted energy storage schedule and the predicted energy delivery schedule at the given time of year. Therefore, the ESS 105/VPP 100 operating schedule is constantly updated based on how the ESS 105/VPP 100 is actually operated.

FIG. 2F shows a flowchart continuing from the method of FIG. 2E, in accordance with an embodiment of the present invention. From either of operations 229 or 231, the method can proceed with an operation 233 to update the historical electrical power load data for the given power consumption facility at the given time of year based on actual operation of the ESS 105 at the given time of year. Then, an operation 235 is performed to execute program instructions on the computer to update the predicted energy storage schedule and the predicted energy delivery schedule for the energy storage technology and configuration of the ESS 105, based on the updated historical electrical power load data for the given power consumption facility at the given time of year, so as to ensure sufficient supply of electrical power to the given power consumption facility at the given time of year.

In an autonomous operation mode, the VPP 100 delivers electric power in accordance with an electric power generation profile produced by a computer-based simulation of VPP 100 operation following the methods of FIGS. 2A-2F. In this manner, electric power delivered by the VPP 100 based on an optimized, lowest-cost combination of ESS 105 and PVPP 103 operations. VPP 100 performance data obtained during VPP 100 operation is added to an existing development database operated on by the computer-based simulation, and the electric power generation profile is updated accordingly. In various embodiments, the development database and electric power generation profile is updated at a rate of at least once per day. In some embodiments, the development database and electric power generation profile is updated at a rate of once per minute. It should be understood, however, that in other embodiments the development database and electric power generation profile can be updated at other rates suitable to capture changes in VPP 100 operation to supply committed or dispatchable electric power.

The VPP 100 can also be controlled to provide for selling of electric power generated by the VPP 100 in an arbitrage manner. For example, due to electric power grid congestion during high demand periods, the wholesale price of energy rises significantly, often to about three times that of low demand periods. Therefore, it can be advantageous for the VPP 100 to schedule a majority of its electric power delivery to take advantage of the higher income potential during high demand periods on the electric power grid. Additionally, higher wholesale prices often continue past the time of day when the PVPP 103 is at maximum electric power output. The ESS 105 can be used to facilitate arbitrage by storing energy produced by the PVPP 103 during maximum electric power output times of the day for later sale during the time of day when the PVPP 103 is not at maximum electric power output but the wholesale prices of energy are high.

In some embodiments, the VPP 100 owner can reconfigure the VPP 100 operating configuration, on a day-ahead basis, so that energy produced by the PVPP 103 early in the day will be stored in the ESS 105 and held for delivery during periods of higher wholesale prices. In one embodiment, the ESS 105 capacity may be increased to provide for storage of a set percentage of the PVPP 103 electric power output for later more profitable delivery. In one embodiment, the additional ESS 105 capacity for arbitrage may be set to accommodate 50% of the PVPP 103 electric power output. However, the set percentage of the PVPP 103 electric power output used to establish ESS 105 capacity for arbitrage can vary as needed. Also, in some embodiments, control of the VPP 100 for arbitrage purposes can be done automatically through the VPP master controller, data acquisition, and communications hub 133 in communication with the PVPP controller and data acquisition system 131 and with the ESS controller and data acquisition system 129 and with the interconnection controller 127. Additionally, the control of the VPP 100 for arbitrage purposes can be done in an iterative manner to take advantage of tariff schedule pricing.

As discussed above with regard to the method of FIGS. 2C and 2D, the VPP 100 can be controlled to provide support services to the electric power grid when directed to do so by either the operator of the electric power grid or by the owner of the VPP 100. For example, when connected to the electric power grid, the VPP 100 can be operated as a voltage source to deliver or absorb reactive power. The VPP 100 can also be operated to help maintain bus voltage within specified limits, or raise bus voltage instantaneously by providing real power so that the electric power grid frequency can be stabilized. In some instances, in order to provide support services to the electric power grid, delivery of electric power from the VPP 100 to the electric power grid may be constrained. To cover these instances, the VPP 100 owner may obtain financial relief, such as capacity payments for making the VPP 100 available to the operator of the electric power grid.

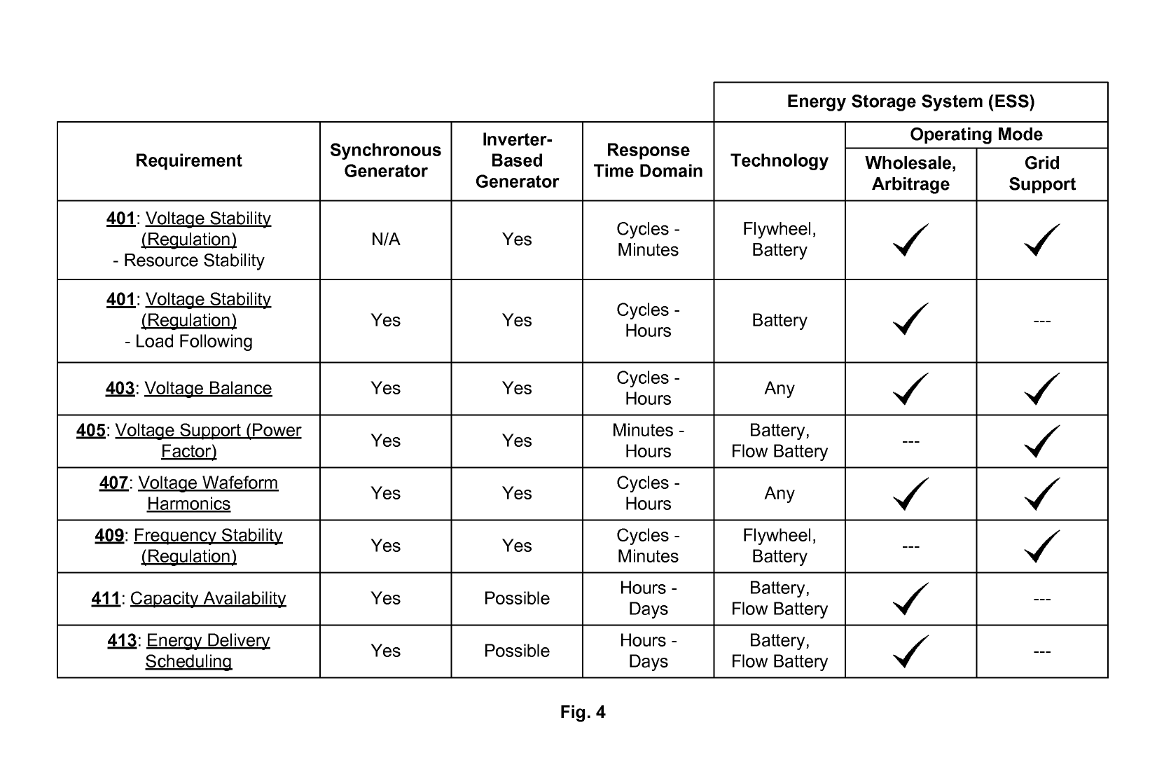

As with other electric power generation units, technical requirements for interconnection of the VPP 100 to the electric power grid (a.k.a. transmission grid) are specified in various American National Standards (ANSI) and Institute for Electrical and Electronic Engineering (IEEE) standards. FIG. 4 shows a chart that summarizes some of the technical requirements that may or may not be applicable for connecting the VPP 100 to the electric power grid, in accordance with an embodiment of the present invention. A requirement 401 for voltage stability (regulation) of the electric power generator is provided. The requirement 401 provides that the electric power generator should comply with standards establishing RMS (root-mean-square) voltage classes and nominal voltage levels, e.g., 72 kV voltage class and 66 kV nominal voltage level. To comply with requirement 401, the electric power generator should maintain their output voltage so that under all conditions of load (zero through 100% of rating) the measured phase-to-phase voltage stays within a specified percentage of nominal. For example, for 72 kV voltage class and 66 kV nominal voltage level, the required voltage range is ±5% of 66 kV. The VPP 100 may be required to maintain voltage stability, but may not be required to perform load following.

There are many types of system faults that are by nature short-lived and do not render the system inoperable. However, during the brief interval of the fault, system voltage can fall precipitously or rise instantaneously, sometimes resulting in separation of a generator from the line. The ESS 105 by way of the VPP 100 can be used to mitigate, or even prevent, voltage excursions that might otherwise result in complete loss of generation.

A requirement 403 for RMS voltage balance by the electric power generator is also provided. The requirement 403 specifies that the voltage between any two phases (ØA-ØB, ØB-ØC, ØA-ØC) does not differ from the other two phases by more than a set percentage, such as 2.5% by way of example. The RMS voltage balance is inversely proportional to the RMS voltage. Therefore, at 230 kV, phase voltages must be kept within 0.5% of each other in accordance with the example above. The VPP 100 may be required to maintain voltage balance.

A requirement 405 for voltage support for power factor correction by the electric power generator is also provided. As mentioned above, electric power generators are responsible for maintaining RMS voltage within set limits under all foreseeable load conditions, including load conditions that are predominantly inductive or capacitive, and load conditions that create non-linear current waveforms. These load conditions result in creation of reactive power flows that detract from the overall capacity to supply the loads while not providing any benefit from doing useful (and billable) work. A power factor (pf) is defined as a ratio of real (billable) power to total (real+reactive) power.

A requirement 407 for RMS voltage harmonic content by the electric power generator is also provided. The requirement 407 specifies that the total harmonic distortion (THD) of the voltage waveform generated by the electric power generator cannot exceed a specified level, which is a geometric sum of all harmonics (integral multiples) of the natural (base) frequency, e.g., 60 Hertz (Hz). In addition, standards may stipulate that no single harmonic can contribute more than a set percentage of THD, such as no more than 60% of THD. For example, where the maximum permissible THD is 5%, no single harmonic can contribute more than 3% of THD. As with voltage balance, the permissible THD is inversely proportional to system RMS voltage. As with other grid-connected generators, the requirement 407 for RMS voltage harmonic content can also apply to the VPP 100.

A requirement 409 for RMS frequency stability by the electric power generator is also provided. The requirement 409 specifies that the nominal AC frequency is 60 Hz (in the United States, Canada, and much of Central/South America). To satisfy the RMS frequency stability requirement 409, the rotating generators of the electric power generator are required to rotate in synchrony such that their frequencies as measured at the points of interconnection to the electric power grid do not vary by more than 0.5 Hz, i.e., such that their frequencies stay within the range from 59.5 Hz to 60.5 Hz. As with other grid-connected generators, the requirement 409 for RMS frequency stability can also apply to the VPP 100. However, as system load increases, the rotating generators supplying the load will tend to slow down, with a resultant lowering of frequency. When this occurs, the ESS 105 by way of the VPP 100 can, on command, inject its full capacity onto the electric power grid, effectively unloading the rotating generators and allowing the transmission line frequency to recover.

Also, synchronous generators may be required to comply with a capacity availability requirement 411 and an energy delivery scheduling requirement 413. For example, there can be requirements for committed amounts and times-of-day for capacity availability and minimum guaranteed energy delivery, satisfaction of which are borne by the synchronous electric power generator. These capacity and scheduling requirements are promulgated by any of a number of Balancing Authorities (BA) or RTO's who are responsible for assuring adequate power flow through the transmission and distribution systems of the electric power grid on a continual basis. Any synchronous electric power generator that participates must commit to both capacity (kW) and times of energy delivery (kWh). If the committed synchronous electric power generator cannot meet the requirements, then the operator of the synchronous electric power generator is obligated to furnish replacement capacity and energy. The VPP 100 is not required to satisfy the capacity availability requirement 411 and the energy delivery scheduling requirements 413. However, the VPP 100 owner can enter into agreements regarding capacity availability and energy delivery scheduling as appropriate based on its own economic and performance objectives.

Methods and systems are disclosed herein by which a static, inverter-based electric generator and its associated intermittent, renewable prime resource is operated in conjunction with the ESS 105 as part of the VPP 100 to emulate the performance of a rotating electric generator (i.e., emulate the performance of a traditional power plant) for fixed, predictable time periods. It should be appreciated that the methods and systems disclosed herein for ESS 105/VPP 100 configuration and operation provide for implementation of intermittent, inverter-based generating resources, such as solar PV and wind, by augmenting their availability and value to the operators of the electric power grid.

The VPP 100 provides for increased electric power grid stabilization, regulation, and reliability. In some embodiments, electric power from static, inverter-based electric generators, such as those having solar and/or wind as their renewable prime resource, is stored by some means, e.g., batteries, within the ESS 105. Then, electric power from the ESS 105 is converted from DC to AC and is released in a controlled manner to supply electricity to a particular facility and/or to the electric power grid to measurably reduce resource inefficiencies while increasing and/or firming scheduled energy deliveries. As discussed herein, the methods and systems associated with the VPP 100 provide for a regulated and dispatchable delivery of electric power from renewable power sources to a particular facility and/or to the electric power grid in a manner that is independent of the availability or capacity of the underlying renewable power sources, while maintaining voltage and frequency at the point-of-common-coupling (PCC) to the electric power grid.

Some of the methods and systems disclosed herein can be implemented as software programs and/or as hardware-based control interfaces through which the software programs effect electrical power plant operation. The methods and system of the PVPP 103, ESS 105, and VPP 100 provide for closely controlled injection of stored electrical energy into a properly prepared transmission or distribution system at an appropriate location. Such appropriate locations may include, but are not limited to, existing or planned generating stations (power plants), transmission and/or distribution substations, and end-use customer points-of-common-coupling. The methods and system of the PVPP 103, ESS 105, and VPP 100 provide for controlled injection of stored electrical energy in a manner that permits pre-selection or time-interactive selection of the proportion of real and reactive power delivered, its voltage and frequency, and the time span during which injection occurs. The methods for providing the controlled injection of stored electrical energy are not dependent on the type and/or nature of the energy storage technology employed. The methods for providing the controlled injection of stored electrical energy to the electric power grid are based upon having an instantaneously available capacity and duration of sufficient stored electrical energy in the ESS 105, i.e., of sufficient charge contained in the energy storage medium.

Also, in some embodiments, the methods disclosed herein can be applied to new renewable power plant construction. In these embodiments, the methods allow the new renewable power plant to be constructed with less excess capacity, thus reducing its capital cost and improving the expected financial returns. For example, the predicted performance of the ESS 105/PVPP 103/VPP 100 over a one year time period can be mapped out and combined with an expected market price for electric power and/or electric power grid support services to determine an expected annual revenue. The expected annual revenue can then be input to a cash-flow analysis, along with anticipated life-cycle costs of the VPP 100, to determine time-to-positive cash flow and expected internal rates of return (IRR) in order to validate the design, construction, and operation of the VPP 100.

Any of the methods of the invention described herein can be embodied as computer readable code on a non-transitory computer readable medium. The non-transitory computer readable medium is any data storage device that can store data that can thereafter be read by a computer system. Examples of the non-transitory computer readable medium include hard drives, network attached storage (NAS), read-only memory, random-access memory, CD-ROMs, CD-Rs, CD-RWs, magnetic tapes, and other optical and non-optical data storage devices. The non-transitory computer readable medium can also be distributed over a network of coupled computer systems so that the computer readable code is stored and executed in a distributed fashion.

Any of the operations described herein that form part of the invention are useful machine operations. The invention also relates to a device or an apparatus for performing these operations. The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data is obtained over a network the data maybe processed by other computers on the network, e.g., a cloud of computing resources.

The embodiments of the present invention can also be defined as a machine that transforms data from one state to another state. The data may represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method for configuring an electrical storage system, comprising:
obtaining historical electrical power load data for a given power consumption facility for a period of time, the period of time being at least one year, the historical electrical power load data represented in Watts of electrical power load as a function of time of day;
executing program instructions on a computer to create a load duration curve for the given power consumption facility for the period of time based on the obtained historical electrical power load data, the load duration curve correlating a percentage of peak power consumption by the given power consumption facility to a percentage of the period of time at which the given power consumption facility consumes the percentage of peak power consumption;
obtaining anticipated electrical power production data for a given inverter-based power generation facility for the period of time, the anticipated electrical power production data represented in Watts of electrical power produced as a function of time of day;
executing program instructions on the computer to create a power generation curve for the given inverter-based power generation facility for the period of time based on the obtained anticipated electrical power production data, the power generation curve correlating a percentage of peak power production by the given inverter-based power generation facility to a percentage of the period of time at which the given inverter-based power generation facility produces the percentage of peak power production;
executing program instructions on the computer to evaluate the power generation curve against the load duration curve to determine a required electrical power supply capacity and duration for the electrical storage system to cover peak power demand of the given power consumption facility; and
determining an energy storage technology and configuration of the electrical storage system sufficient to satisfy the required electrical power supply capacity and duration for the electrical storage system to cover peak power demand of the given power consumption facility.

2. The method as recited in claim 1, further comprising:
prior to executing program instructions on the computer to create the load duration curve, executing program instructions on the computer to perform a smoothing operation on the obtained historical electrical power load data so as to ensure existence of either an actual electrical power load data point or an interpolated electrical power load data point at each fifteen minute interval over the period of time, and so as to remove any corrupt electrical power load data point over the period of time.

3. The method as recited in claim 1, wherein the given inverter-based power generation facility is connected to supply power to the given power consumption facility.

4. The method as recited in claim 1, wherein the given inverter-based power generation facility generates electrical power through one or both of solar photovoltaic cells and wind turbines.

5. The method as recited in claim 1, wherein the given inverter-based power generation facility is controlled by the given power consumption facility.

6. The method as recited in claim 1, wherein the load duration curve based on the historical electrical power load data represents a true electrical power load for the given power consumption facility at all times during the period of time within a selected confidence interval.

7. The method as recited in claim 6, wherein the selected confidence interval is set at 95%.

8. The method as recited in claim 1, further comprising:
executing program instructions on a computer to simulate electrical power generation by the given inverter-based power generation facility during the period of time to produce the anticipated electrical power production data for the period of time.

9. The method as recited in claim 1, wherein the required electrical power supply capacity for the electrical storage system to cover peak power demand of the given power consumption facility is determined by calculating an amount of electrical power corresponding to a maximum extent by which the load duration curve exceeds the power generation curve at any given time within the period of time.

10. The method as recited in claim 1, wherein the required electrical power supply duration for the electrical storage system to cover peak power demand of the given power consumption facility is determined by calculating a total amount of time at which the load duration curve exceeds the power generation curve during the period of time.

11. The method as recited in claim 1, wherein the energy storage technology is a battery bank including a number of batteries, and wherein the energy storage technology and configuration includes specification of respective voltages of the number of batteries, respective amperages of the number of batteries, and electrical connections between terminals of the number of batteries.

12. The method as recited in claim 1, further comprising:
executing program instructions on the computer to quantify differences in electrical power production capacity and duration between the power generation curve for the given inverter-based power generation facility for the period of time and an ideal power generation curve for the given inverter-based power generation facility for the period of time, the ideal power generation curve based on ideal power production conditions for the given inverter-based power generation facility, the ideal power generation curve correlating a percentage of peak power production by the given inverter-based power generation facility under ideal power production conditions to a percentage of the period of time at which the given inverter-based power generation facility produces the percentage of peak power production under ideal power production conditions; and
determining adjustments to one or both of the energy storage technology and configuration of the electrical storage system to provide compensation in power supply capacity and duration for non-ideal power production conditions so as to sufficiently cover the quantified differences in electrical power production capacity and duration between the power generation curve for the given inverter-based power generation facility for the period of time and the ideal power generation curve for the given inverter-based power generation facility for the period of time.

13. The method as recited in claim 12, wherein sufficient coverage of the quantified differences in electrical power production capacity and duration between the power generation curve for the given inverter-based power generation facility for the period of time and the ideal power generation curve for the given inverter-based power generation facility for the period of time exists when a sum of the electrical power supply capacity for the electrical storage system and the electrical power production capacity of the given inverter-based power generation facility is at least 95% of the electrical power production capacity of the given inverter-based power generation facility under ideal power production conditions at all times during the period of time.

14. The method as recited in claim 12, further comprising:
obtaining an availability requirement for the electrical storage system in terms of a minimum power supply capacity and duration to an electric power grid; and
determining adjustments to one or both of the energy storage technology and configuration of the electrical storage system to provide additional power supply capacity and duration to meet the availability requirement while simultaneously covering the peak power demand of the given power consumption facility and providing compensation in power supply capacity and duration for non-ideal power production conditions.

15. The method as recited in claim 14, further comprising:
determining an ability of the electrical storage system to support operation of the electric power grid with regard to voltage and frequency during transient conditions on the electric power grid while simultaneously covering the peak power demand of the given power consumption facility and providing compensation in power supply capacity and duration for non-ideal power production conditions; and
communicating to an operator of the electric power grid the ability of the electrical storage system to support operation of the electric power grid with regard to voltage and frequency during transient conditions on the electric power grid.

16. The method as recited in claim 15, further comprising:
enabling the operator of the electric power grid to take over control of the electrical storage system during transient conditions on the electric power grid.

17. The method as recited in claim 1, further comprising:
based on the historical electrical power load data for the given power consumption facility for the period of time, executing program instructions on a computer to create a predicted energy storage schedule and a predicted energy delivery schedule for the energy storage technology and configuration of the electrical storage system so as to ensure sufficient supply of electrical power to the given power consumption facility during the period of time, the period of time being one year; and
operating the electrical storage system at a given time of year in accordance with the predicted energy storage schedule and the predicted energy delivery schedule corresponding to the given time of year.

18. The method as recited in claim 17, further comprising:
adjusting operation of the electrical storage system at the given time of year based on a real-time electrical power demand not covered by the predicted energy storage schedule and the predicted energy delivery schedule at the given time of year.

19. The method as recited in claim 18, further comprising:
updating the historical electrical power load data for the given power consumption facility at the given time of year based on actual operation of the electrical storage system at the given time of year; and
based on the updated historical electrical power load data for the given power consumption facility at the given time of year, executing program instructions on the computer to update the predicted energy storage schedule and the predicted energy delivery schedule for the energy storage technology and configuration of the electrical storage system so as to ensure sufficient supply of electrical power to the given power consumption facility at the given time of year.

20. The method as recited in claim 19, further comprising:
operating the electrical storage system in accordance with an order issued by an operator of an electric power grid to which the electrical storage system is connected, wherein the order causes the real-time electrical power demand not covered by the predicted energy storage schedule and the predicted energy delivery schedule at the given time of year.

21. A non-transitory computer readable storage medium having program instructions stored thereon for generating a configuration of an electrical storage system, comprising:
program instructions for creating a load duration curve for a given power consumption facility for a period of time based on historical electrical power load data for the given power consumption facility for the period of time, the period of time being at least one year, the historical electrical power load data represented in Watts of electrical power load as a function of time of day, the load duration curve correlating a percentage of peak power consumption by the given power consumption facility to a percentage of the period of time at which the given power consumption facility consumes the percentage of peak power consumption;
program instructions for creating a power generation curve for a given inverter-based power generation facility for the period of time based on anticipated electrical power production data for the given inverter-based power generation facility for the period of time, the anticipated electrical power production data represented in Watts of electrical power produced as a function of time of day, the power generation curve correlating a percentage of peak power production by the given inverter-based power generation facility to a percentage of the period of time at which the given inverter-based power generation facility produces the percentage of peak power production;
program instructions for evaluating the power generation curve against the load duration curve to determine a required electrical power supply capacity and duration for the electrical storage system to cover peak power demand of the given power consumption facility; and
program instructions for determining an energy storage technology and configuration of the electrical storage system sufficient to satisfy the required electrical power supply capacity and duration for the electrical storage system to cover peak power demand of the given power consumption facility.
